(19) United States
(12) Patent Application Publication
(10) Pub. No.: US 2004/0213720 A1
(43) Pub. Date: Oct. 28, 2004

(54) Method for treating flue gases containing ammonia

(76) Inventors: Christian Wolf, Dortmund (DE); Kai Keldenich, Essen (DE); Thomas Marzi, Duisburg (DE); Tetsuro Toda, Dusseldorf (DE); Tomoyuki Imai, Hiroshima-ken (JP)

Correspondence Address: NIXON & VANDERHYE, PC, 1100 N GLEBE ROAD, 8TH FLOOR, ARLINGTON, VA, 22201-4714, US

(21) Appl. No.: 10/477,132

(22) PCT Filed: May 13, 2002
(86) PCT No.: PCT/EP02/05247

(30) Foreign Application Priority Data
May 14, 2001 (DE) 101 23 402.3

(51) Int. Cl. B01D 53/58

(52) U.S. Cl. 423/237

(57) ABSTRACT

The invention relates to a method for removing ammoniacal components of a flue gas that has been treated according to the SNCR method, wherein the method is characterized in that the flue gas is contacted at a temperature, that is at least 150° C. below that at which the SNCR method is carried out, with a ferro-oxidic catalyst having a specific surface area of at least 0.2 m²/g, measured according to the BET method. Preferably, the catalyst is added to the flue gas at a temperature of 700-400° C. of the gas in the flue channel.

The present invention concerns a method for treating flue gases resulting when combusting gaseous, solid or liquid fuels and subjecting them to a downstream treatment according to the SNCR method.

Nitrogen oxides, but also ammonia, are compounds that are undesirable in the outgoing air of combustion processes because they impact and partially poison the environment. Nitrogen oxides (NOₓ) occur process-internally when combusting nitrogen-containing materials. For a long time, there have been regulatory limit values for the quantity of tolerable NOₓ gas. In order to be able to maintain these values, a significant method-technological expenditure is usually required in order to remove the produced gases from the flue gas. However, hardly any attention has been paid to the presence of ammonia and ammoniacal compounds, inter alia, because the observance of limit values in regard to gases has not been regulated by law as yet.

An often employed method for reducing the nitrogen oxide contents is the selective non-catalytic reduction (SNCR) of flue gases by injecting NH-containing reducing agents (for example, aqueous ammonia, compounds that form ammonia, or amines) within a fixed temperature window. Published German-patent document 24 11 672 of Exxon Research and Engineering Company describes this method. In this method, a defined quantity of ammonia or an ammonia precursor (for example, aqueous ammonia) is contacted in the presence of oxygen at 870° C. to 1,095° C. (in practice, a temperature window of 950° C. to 1,150° C. is conventional) with the nitrogen oxide-containing flue gas, inasmuch as the method is carried out in the absence of additional reducing agents. The quantity range is given as 0.4 to 10 mol of ammonia per mol of nitrogen monoxide. At such high temperatures, NOₓ is reduced to nitrogen without the presence of an additional catalyst, while ammonia or the NH-containing compound is oxidized to N₂ and water. However, the NH-containing reducing agent is added always in over-stoichiometric quantities in practice.

When using over-stoichiometric quantities of NH-containing reducing agent for NOₓ, slip of produced or residual ammonia cannot be prevented. This ammonia slip can cause problems upon further treatment of the flue gas because ammonia is stripped, for example, in the washing water of a wet flue gas scrubber or is adsorbed on deposited solid residual materials. The qualities of the solid residues are thus lowered because ammonia can desorb at the storage facilities and can impair air quality.

In addition to the SNCR method, the use of the SCR method is also common. In this method, a stationary catalyst is provided in an area of the flue gas discharge or boiler, which area has a significantly lower temperature (approximately 300° C.). The untreated as well as the pre-treated flue gas can be treated with this catalyst. SCR catalysts are, in general, honeycomb catalysts that are essentially comprised of titanium metal oxides, vanadium metal oxides, or other transition metal oxides.

Recently, a new method for reducing over-stoichiometric ammonia when employing the SNCR method has been published according to which, downstream of the NOₓ reduction, a so-called slip catalyst is arranged in a high-dust arrangement (i.e., in the area of the not yet dust-filtered flue gas) and in a temperature window of approximately 400-200° C. This method is to be employed in the refuse power plant Mainz whose construction has been ordered in October 1999; this method is supposedly especially suitable for refuse incinerators. However, the method has the disadvantage that the catalyst has the tendency to become caked and plugged as a result of the high possible proportion of dust in the flue gas at the predetermined location. Moreover, the acidic components or heavy metals in the flue gas can poison the catalyst so that its operativeness will be lost.

It is an object of the present intention to provide a method with which the ammoniacal components of a flue gas treated with the SNCR methods can be removed therefrom.

This object is solved in that the flue gas is contacted within a temperature window that is significantly (at least 150° C.) below that in which the SNCR method is employed today, preferably in the range of 700-400° C., with a ferro-oxidic catalyst that has a specific surface area of at least 0.2 m²/g, measured according to the BET method (Merffert and Langenfeld, Z. Anal. Chem. 238 (1968), 187-193).

By adding an iron oxide catalyst having a very high specific surface area at a location of the flue gas discharge that is arranged downstream of the injection location of the ammoniacal reducing agent, it is achieved that excess ammonia is converted completely to N₂and H₂O, even at comparatively low temperatures. The added catalyst is capable of releasing oxygen bonded on the solid material into gaseous substances by a solid state contact reaction and of regenerating by taking up oxygen from the flue gas.

Oxygen is frequently still present within the flue gas leaving the combustion chamber, for example, in the form of oxygen that was contained in the primary combustion air injected into the combustion chamber for maintaining the combustion process. Moreover, air (so-called secondary or tertiary air) is usually injected additionally into the rising combustion gases in order to carry out after combustion of the not yet completely converted flue gases. This can be realized in a flue gas channel adjoining the combustion chamber, for example, at a constricted area. Also, other mixing media such as pressurized steam or recirculated flue gas can be added, as is known in the prior art. These measures serve, in addition to supplying additional oxygen, also for improving the mixing process, in order to improve contact of the flue gases that have not yet been completely combusted with oxygen.

Preferably, the ferro-oxidic catalyst of the present invention has a specific surface area in the range of 0.2 to 200 m²/g, preferably of more than 2 m²/g, even more preferred of more than 20 m²/g. A high specific surface area is beneficial because in this way the required quantity of catalyst can be lowered.

In addition to the effects of a possible undesirable temperature drop or the requirement of having to preheat the catalyst, which effects and requirements become disadvantageous with increasing quantity of catalyst, a reduced catalyst amount is also advantageous for cost considerations because the catalyst removed during the process generally cannot be recycled.

In order to effect the aforementioned large specific surface area, it is preferred that the catalyst particles are as small as possible. Also, the distribution of the catalyst is improved in this way. Suitable are particle sizes in the range of approximately 0.01 μm or more; preferably, 2 μm should not be surpassed. Especially beneficial are particles in the size range between 0.1 and 20 μm.

Moreover, the catalyst should preferably contain only few contaminants. Preferably, the proportion of phosphorus is less than 0.02% by weight, the proportion of sulfur is less than 0.6% by weight, and the proportion of sodium is less than 0.5% by weight.

The quantity of catalyst to be used depends primarily on the selected stoichiometry of the SNCR method and the geometric boundary conditions at the location of injection. A suitable quantity range is between 0.01 and 0.5 g/Nm³ flue gas.

Preferably, the catalyst has such properties that it can convert at least 15% carbon monoxide into carbon dioxide when 2.8×10⁻⁴ mol catalyst, after 15 minutes heat exposure and contact with air at 800° C., is contacted immediately with 6.1×10⁻⁷ mol carbon monoxide at 250° C. at a space velocity of 42,400 h⁻¹ in an inert atmosphere in a pulsating catalytic reactor.

The addition of the catalyst to the flue gas should preferably be realized in a temperature window in which the flue gas is heated to a temperature of 700-400° C. In this range, the present ammonia or the NH-containing medium is completely decomposed while possibly still present NOₓ is reduced further. When the the ammonia is oxidized to nitrogen monoxide. At low temperatures, the efficiency of the conversion decreases.

The catalyst is preferably injected by means of a carrier medium of compressed air or dry steam into the flue gas channel. However, other carrier media are possible, for example, recirculated flue gas.

The method is suitable for all combustion methods, preferably methods for combusting heterogeneous solid materials as they are used in refuse and residual material incinerators as well as biomass power plants where nitrogen oxides in the flue gas are to be minimized or removed by means of the SNCR method.

By injecting the catalyst, the ammonia slip in the flue gas is completely or mostly eliminated and ammonia is converted to innocuous components. In this way, the processes carried out downstream are not impaired by the undesirable ammonia or their efficiency is not lowered.

Preferably, the method according to the invention is carried out such that, at a suitable location within the flue gas chimney, first the nitrogen oxide concentration is measured in the flue gas in a way known in the art. Based on the measured concentration, the quantity of ammonia, or another NH-containing medium, to be used in the SNCR method is determined, wherein the stoichiometry is already preliminarily determined. By means of a temperature measurement in the area of injection of the reducing agent, the optimal location is determined that results from the parameters for the above described temperature window in the SNCR method.

Based on the selected or predetermined process parameters, subsequently the quantity of the catalyst to the injected is determined according to the present invention, for example, based on the selected stoichiometry in the SNCR method. It is injected into the flue gas at the selected location. The gaseous carrier medium for the finely divided solid material is preferably compressed air or dry steam but also recirculated flue gas.

As a function of the cross-sectional surface area of the flue gas chimney at the injection location, preferably two (possibly also more) injectors are used, even when in some cases only one injector is sufficient in order to achieve the required complete mixing into the flue gas while using a minimal carrier gas quantity.

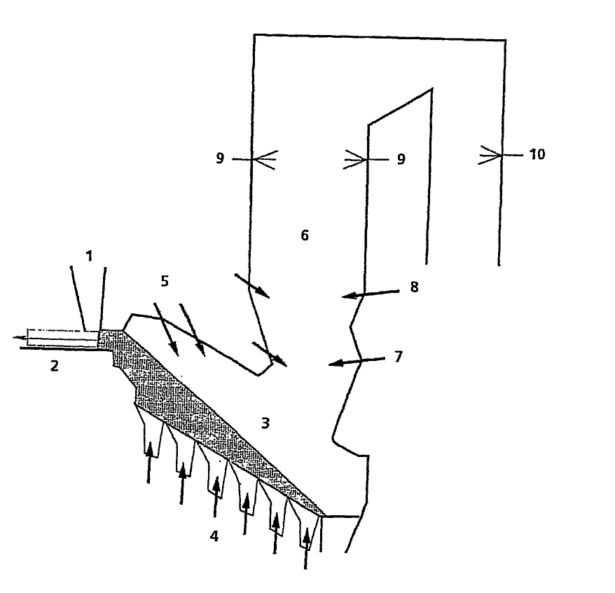

FIG. 1 shows schematically a combustion with flue gas treatment by means of which the method according to the invention is to be explained in more detail. The illustrated conditions are provided only as an example and are not to limit the subject matter of the invention in any way.

FIG. 1 illustrates a combustion process where refuse is added (1) as a fuel. By means of a feed slide (2) the fuel is pushed into the combustion chamber (3). The fuel is combusted therein by adding primary combustion air (4). The combustion products that rise from the solid material bed can be mixed intimately with one another by the targeted addition of mixing media (5). After mixing, at the transition from the combustion chamber to the secondary combustion chamber (6), injection of additional combustion air (secondary air 7 or tertiary air 8) takes place. In the downstream area of the flue gas chimney (9) at a location of suitable temperature the SNCR method is carried out in that ammonia or another NH-containing compound is administered. Within the further extension of the flue gas chimney or of the boiler (19), the catalyst can be added to (injected into) the flue gas. The location of the catalyst addition is not critical with regard to spatial conditions; it is selected exclusively, or primarily, with regard to the temperatures that are present in order to fulfill the criteria of the desirable temperature window. The only criterion that must be observed is that the location of addition of the catalyst is located at a sufficient spacing relative to the location of the SNCR nitrogen oxide reduction in order to ensure that the ammonia slip of this method is completely converted by the catalyst.

1. A method for removal of ammoniacal components of a flue gas that has been treated by the SNCR method, characterized in that the flue gas is contacted at a temperature, that is at least 150° C. below that at which the SNCR method is carried out, with a ferro-oxidic catalyst, having a specific surface area of at least 0.2 m²/g, measured according to the BET method.

2. The method according to claim 1, characterized in that the catalyst is added to the flue gas at a temperature of 700-400° C. of the gas in the flue gas channel.

3. The method according to claim 1, characterized in that the catalyst is injected by means of a carrier medium comprised of compressed air, dry steam, or recirculated flue gas.

4. The method according to claim 1, characterized in that the ferro-oxidic catalyst has a specific surface area in the range of 0.2 to 200 m²/g, preferably of more than 2 m²/g, even more preferred of more than 20 m²/g.

5. The method according to claim 1, characterized in that the proportion of phosphorus in the ferro-oxidic catalyst is less than 0.02% by weight, the proportion of sulfur therein is less than 0.6% by weight, and the proportion of sodium therein is less than 0.5% by weight.

6. The method according to claim 1, characterized in that the catalyst can convert at least 15% carbon monoxide into carbon dioxide, when 2.8×10⁻⁴ mol catalyst, after 15 minutes heat exposure and contact with air at 800° C., is contacted immediately with 6.1×10⁻⁷ mol carbon monoxide at 250° C. at a space velocity of 42,400 h⁻¹ in an inert atmosphere in a pulsating catalytic reactor.
